(19) United States
(12) Patent Application Publication
(10) Pub. No.: US 2010/0171314 A1
(43) Pub. Date: Jul. 8, 2010

(54) Vertically Oriented Wind Tower Generator

(76) Inventor: Justin Dale Tackett, Fort Worth, TX (US)

Correspondence Address: WILSON DANIEL SWAYZE, JR., 3804 CLEARWATER CT., PLANO, TX, 75025, US

(21) Appl. No.: 12/350,299

(22) Filed: Jan. 8, 2009

(51) Int. Cl. F03D 9/02

(52) U.S. Cl. 290/55

(57) ABSTRACT

A power generator may include a housing to house the power generator, an inlet chamber to import fluid, a compression chamber to compress the fluid from the inlet chamber, a turbine chamber including a vertical turbine to generate power from the compressed fluid, and an outlet chamber to output the exhaust fluid. The inlet chambers may include a rotatable baffle to open and close the inlet chamber. The outlet chamber may cooperate with the opening and closing of the baffles, and the outlet chamber may includes an output port at the direction of the outlet port is opposed to the open baffles.

### FIELD OF THE INVENTION

The present invention relates to wind generators and more particularly to a wind generator that has a vertical orientation.

### BACKGROUND OF THE INVENTION

As the price of oil continues to rise, it becomes desirable to use alternative fuels. However, the supply of some fuels may be limited, and it would be desirable to employ a renewable source of energy that would be reliable and economical to use it. In many areas of the country, there is an ample supply of wind power, but for the most part, the ability to harness this power has not been realized. Traditionally, a large turbine blade may be required which may be oriented in the horizontal direction. While these types of turbine generators may be appropriate for use in the countryside, the necessary space to use these large turbine blades may not be available in an urban setting. In this kind of setting, real estate is generally expensive, and this expense usually dictates the use of a high-rise building. Historically, wind turbines has been found in rural areas, requiring the use of long transmission lines in order to transmit the electrical power to the urban areas where the need for electricity is the greatest. These long transmission lines may add significant cost to the price of generating electricity. There is a need for a source of inexpensive electricity which may be used in conjunction with high-rise buildings.

There are many types of windmills designed specifically for electric power generation. These windmills range in scope from a capacity for a single dwelling up to some rather large units that have been built and function with limited success.

Among the schemes presently being proposed is to construct windmills 200 feet high and having blades sweeping a 36 foot diameter circle. At wind speeds of, for example, 22 miles per hour, such windmills are capable of producing 35 KW, and even when the wind velocity falls as low as 4.5 miles per hour, such windmills can produce 0.5 KW. It will be appreciated, however, that the locations having the requisite prevailing winds to just such windmills is rather limited.

With all the schemes that now exist or are being researched, there are common problems that must be overcome to make the cost of the generated power within reason. Some of the most major of these problems are:

Finding locations where the wind is. Obviously, a windmill should be located where the wind blows most of the time with sufficient force to keep the rotor turning a high percentage of the time. There are locations where this condition exists, but even there the wind is variable and unpredictable and will vary in velocity from, for example, zero to hurricane forces.

Structural requirements. Most designs for wind generators have a shaft oriented on a horizontal axis, and the rotors are disposed in a vertical plane. Therefore, the following structural problems must be considered.

The supporting tower must be at least as tall as half the diameter of the rotor assembly.

The rotor arms must not only support their weight from one end, that end being at the shaft, but must be able to withstand the highest conceivable wind loads, or be retractable in some manner.

The lateral force of the wind load is transferred to the tower, so that the tower must be reinforced to resist this bending moment as well as the weights of all the components.

To take the fullest advantage of the available winds, the structure should allow for “weather-vaning” which further complicates structural problems.

Storage. The electricity that is generated will fluctuate, and accordingly must be stored in a system that can then release the electricity at a given rate in a controlled fashion. This can be done with batteries, by means of cryogenic systems, compressed air, or fly wheel storage systems, but for an installation of any size, the most common and most practical solution at this time is to use a conventional power grid.

Transmission. The final step in converting wind power to electricity is to transmit the power, through a transmission system, to the ultimate consumer.

From the above criteria, it is obvious that to harness wind power with working facilities is a costly business. The larger the facility, the more complex and costly it becomes. The larger rotor diameters are very desirable. The general formula for computing wind power is that the power varies as the cube of the velocity of the air and of circular areas through which it passes. When large facilities which are being considered are constructed, they will most likely be on the ocean, on top of mountain peaks, or on very high towers in the plains regions to be “where the wind is”. Therefore, the cost associated with the structure will be great and the storage and transmission costs will also be high, due to the remoteness of the most desirable locations for locating such windmills.

U.S. Pat. No. 4,036.916 discloses a wind driven electric power generator having a shroud arranged in a path of fluid flow. Within the shroud is disposed a stationary shaft supporting a wind generator assembly. The shroud can be the veil of a conventional cooling tower, with the wind generator assembly including a rotor connected to an electric generator arranged for converting rotary motion of the rotor to electrical energy, thus saving some of the energy created by the natural draft passing up the veil of the cooling tower. Space frame box trusses provided with airfoils provide lightweight arms for the rotor, with the rotor being arranged anywhere in the shroud. When a hyperbolic cooling tower veil is used as the shroud, the rotor will usually be positioned in the throat of the veil.

### SUMMARY

A power generator may include a housing to house the power generator, an inlet chamber to import fluid, a compression chamber to compress the fluid from the inlet chamber, a turbine chamber including a vertical turbine to generate power from the compressed fluid, and an outlet chamber to output the exhaust fluid.

The inlet chambers may include a rotatable baffle to open and close the inlet chamber.

The outlet chamber may cooperate with the opening and closing of the baffles, and the outlet chamber may includes an output port at the direction of the outlet port is opposed to the open baffles.

The generated power may be used to store hydrogen, and the turbine may include at least five blades.

The turbine may include a disk to cooperate with the turbine blades, and the fluid may be air.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the power generator of the present invention;

FIG. 2 illustrates a circuit diagram of the controller and the inlet and outlet baffles;

FIG. 3 illustrates a cross-sectional view of the power generator of the present invention;

FIG. 4 illustrates a top view of the power generator of the present invention.

FIG. 5 illustrates another power generating system;

FIG. 6 illustrates the open and closed baffles;

FIG. 7 illustrates a sectional view of the upper portion of the system

FIG. 8 illustrates an outside side view of the system

### DETAILED DESCRIPTION

The present invention may employ a circular housing with a multitude of walls which radially extend from substantially the center of the circular housing. The walls may be substantially perpendicular to the bottom of the housing and the walls may be covered in order to form a multitude of tunnels which may extend radially. The tunnels may be selectively opened and closed in order that the entrance to a portion of the tunnels may be opened to allow the fluid such as air to enter in response to the wind. Another portion of the tunnels may be closed in order to prevent the fluid such as the air from escaping. The tunnels may be referred to as chambers and may be of the form of a truncated pie shape. There may be ten inlet chambers, or fewer or more inlet chambers. The inlet chambers may divert existing wind flow towards the center of the building. The present invention diverts a substantially wide swath of fluid flow into a smaller area in order to extract the maximum power generating potential. In general, the present invention may employ inlet baffles/panels in order to open and close the inlet chambers. The present invention includes a turbine chamber in order to house the vertical turbines and a controlled outflow chamber in order to exhaust the fluid flow from the housing. The outflow chamber may include outlet baffles which are selectively movable in order to open and close generally in opposing directions to the opened or closed inlet baffles. Both the inlet and outlet baffles may be computer-controlled in order to advantageously achieve the maximum wind velocity. The baffles may be opened to allow fluid to flow to a compression chamber and closed on the opposing side of the chamber to form an obstruction and to divert the incoming fluid upwards. The present invention may open four of the 10 inlet baffles and may close the remaining six inlet baffles on the opposing side of the compression chamber. The compression chamber may act like a pipe elbow that can be virtually turned by opening and closing the proper inlet baffles and may provide an upward and slightly compressed flow of fluid in order to introduce the fluid flow to the turbine and turbine blades positioned within the turbine chamber. The turbines are rotated by the motion of the fluid flow and the rotation of the turbines may be used to generate electricity. Since the speed of the turbines may fluctuate, AC generation at a constant frequency may be difficult. However, DC generation with the turbines is advantageous and the DC power generation may be changed to AC generation in accordance with the needs of the user.

The turbine chamber may include a five drive-rotor multi-blade turbine which may be mounted on a single common shaft and may include four turbulence-abatement discs which may be positioned between the rotating blades in order to reform the fluid flow as they fluid flows between one drive rotor to the next. The main flow of the fluid may be directed to the outer portions of the circumference of the blades in order to achieve more efficient use of the fluid flow.

The shaft can be used to provide power to power utilization devices such as alternators for electrical power generation or pumps for hydroelectric transmission etc. Multiple alternators may be mounted on the common shaft and multiple alternators may provide flexibility and redundancy. The turbine chamber may extend from the fluid compression chamber to the outflow chamber and may be short but may be longer in order to take advantage of the ‘chimney effect’ due to the difference of elevation. The turbine chamber may be positioned within the center of a high-rise building in order to provide electricity for the building and to avoid the aesthetics of the turbine chamber. Furthermore, in order to increase the efficiency of a generation of electricity, waste heat from building including heat from air conditioners, attics or other heat sources can be diverted into the combustion chamber in order to increase the efficiencies due to the chimney effect. The outflow chamber provides a controlled outflow of the exhaust fluid and provides a acceleration due to the fluid flow and the flared down wind construction of the outflow chamber. The movable panels of the outflow chamber provide a small vortex which may be downwind of the outflow chamber and may create a vacuum at the output port of the outflow chamber. During normal operating conditions, the open/close ratio should remain in a reverse order from the inlet baffles to the outlet baffles.

For example, if the input baffles are opened 6 to 10 then the output baffles should be opened 4 to 10. During serious weather conditions, all of the output baffles can be closed in order to prevent debris from falling into the apparatus.

The housing should be constructed to withstand the pressures encountered in a force five hurricane or force five tornado. The shape of the housing may allow robust construction and minimum resistance to high wind speed. All of the baffles may be closed in order to provide maintenance work inside the combustion chamber. The turbine assembly can be lowered and disassembled inside the compression chamber and the opening should be sufficiently large in two moved disassembled turbine blades out for replacement, balancing etc.

The input port to the inlet chambers may be covered with inlet screening which may include a lease steel grids to prevent debris from entering the inlet chamber.

As discussed before, either AC or DC power can be generated. The DC power can be used to generate a 60 cycle sine wave output to the power grid, variable frequency alternating current power to AC variable speed motors, voltage controlled output to DC devices, hundred and generation and other power conversion devices. Low-cost hydrogen generation is expected to be of rapidly increasing value due to the development of add-on hydroxide hydrogen storage tanks that can convert a large number of existing internal combustion power automobiles to hydrogen fuel. These automobiles can be switched to hydrogen for extended range and lower consumption a gasoline.

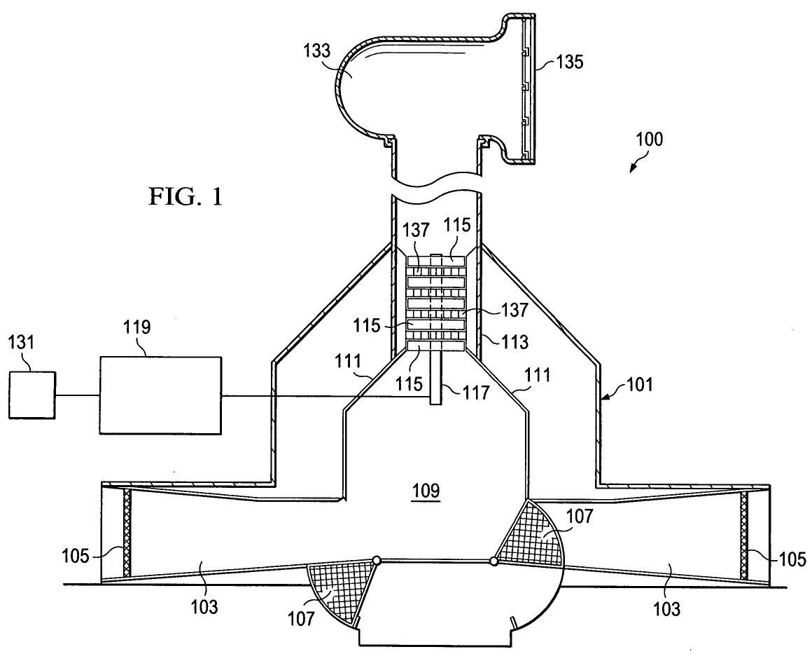

FIG. 1 illustrates a cross-sectional view of the power generating system 100 of the present invention. The power generating system 100 may include a housing 101 which may include inlet chambers 103 which extend along the base of the housing 101. At the distal end of the inlet chambers 103, inlet screens 105 prevent debris from entering the inlet chambers 103. At the proximal end of the inlet chambers 103, rotatable baffles 107 are positioned to open and close in accordance with the operation of the controller 201. When open, the rotatable baffles 107 opened the inlet chamber 103 to the fluid compression chamber 109, and when closed, the rotatable baffles 107 close the inlet chamber 103 to the fluid compression chamber 109. The fluid compression chamber 109 may have inwardly sloping walls 111 in order to compress the fluid and increase the fluid speed. The compressed fluid next enters the turbine chamber 113 which may include vertical turbine blades 115 which may be mounted on a single shaft 117. The turbine chamber 113 may include a five drive-rotor multi-blade turbine which may be mounted on a single common shaft 117 and may include four turbulence-abatement discs 137 which may be positioned between the rotating blades in order to reform the fluid flow as they fluid flows between one drive rotor to the next. The vertical turbine blades 115 may be mounted on multiple shafts. The shaft 117 may be connected to a generator 119 which may be a DC generator or an AC generator. The generator 119 may generate electricity for immediate use or maybe transferred to the power grid. Alternatively, the electricity could be used to generate hydrogen and the hydrogen may be stored in a hydrogen storage tank 131. The exhaust fluid exits the turbine chamber 113 and enters the controllable outflow chamber 133 which may be rotatable and which may have a flared exit port 135.

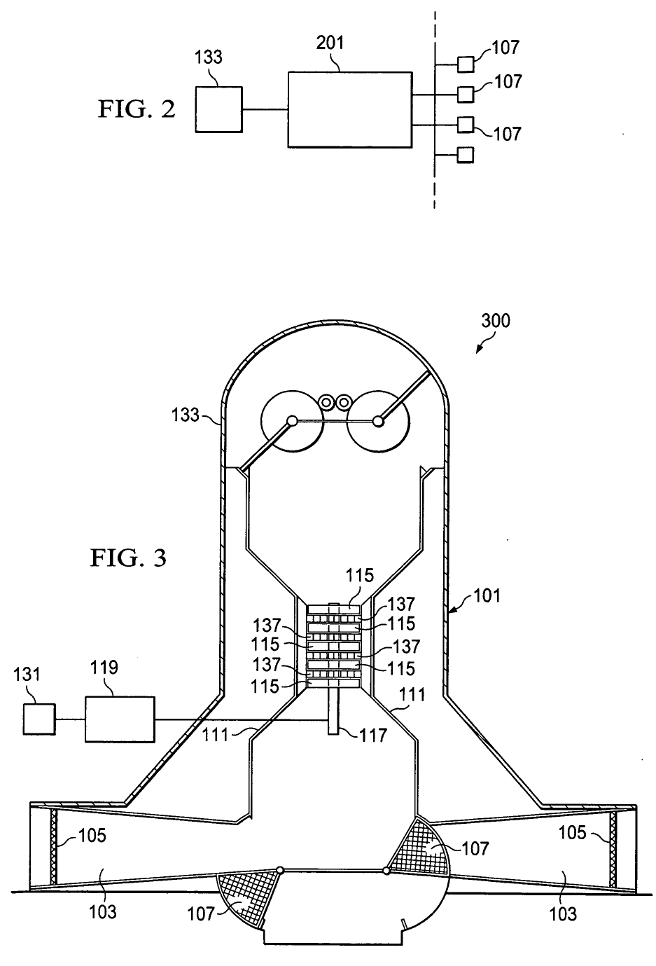

FIG. 2 illustrates that controller 201 controls the rotatable baffles 107 and controls the controlled outflow chamber 133 so that the open baffles 107 are in a proposed direction with respect to the controlled outflow chamber 133.

FIG. 3 illustrates a cross-sectional view of the power generating system 300 of the present invention. The power generating system 300 may include a housing 101 which may include inlet chambers 103 which extend along the base of the housing 101. At the distal end of the inlet chambers 103, inlet screens 105 prevent debris from entering the inlet chambers 103. At the proximal end of the inlet chambers 103, rotatable baffles 107 are positioned to open and close in accordance with the operation of the controller 201. When open, the rotatable baffles 107 opened the inlet chamber 103 to the fluid compression chamber 109, and when closed, the rotatable baffles 107 close the inlet chamber 103 to the fluid compression chamber 109. The fluid compression chamber 109 may have inwardly sloping walls 111 in order to compress the fluid and increase the fluid speed. The compressed fluid next enters the turbine chamber 113 which may include vertical turbine blades 115 which may be mounted on a single shaft 117. The turbine chamber 113 may include a five drive-rotor multi-blade turbine which may be mounted on a single common shaft 117 and may include four turbulence-abatement discs 137 which may be positioned between the rotating blades in order to reform the fluid flow as they fluid flows between one drive rotor to the next. The vertical turbine blades 115 may be mounted on multiple shafts. The shaft 117 may be connected to a generator 119 which may be a DC generator or an AC generator. The generator 119 may generate electricity for immediate use or maybe transferred to the power grid. Alternatively, the electricity could be used to generate hydrogen and the hydrogen may be stored in a hydrogen storage tank 131. The exhaust fluid exits the turbine chamber 113 and enters the controllable outflow chamber 133.

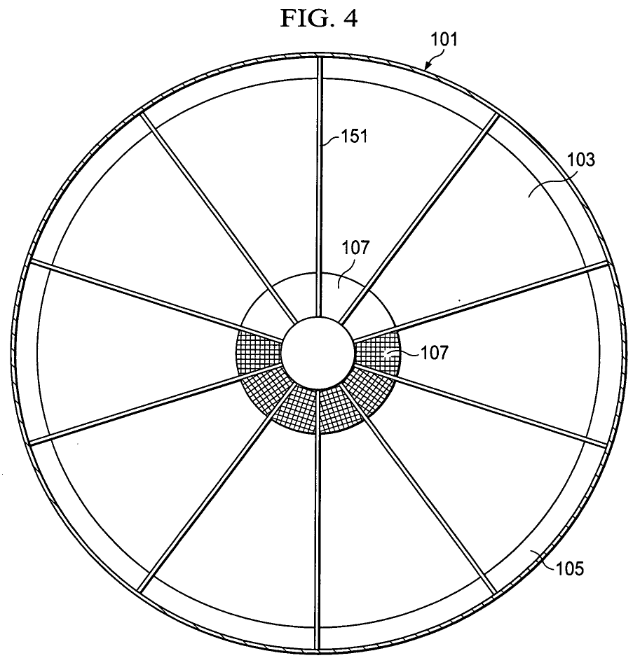

FIG. 4 illustrates a top view of the housing 101 and more particularly the inlet chamber 103 which may be defined by vertical walls 151. Additionally, FIG. 4 illustrates the rotatable baffles 107 and illustrates that four baffles 107 are open and six baffles 107 are closed.

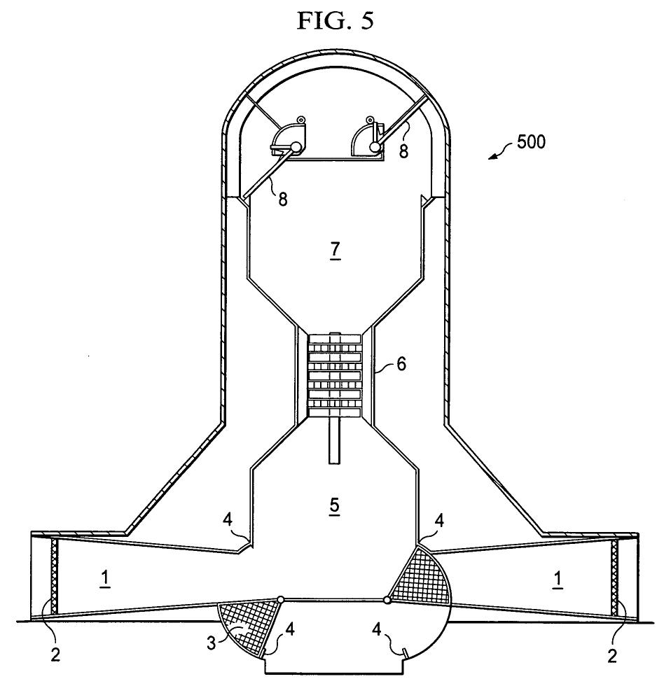

FIG. 5 illustrates another power generating system 500 which may include air inlet tunnels 1. The power generating system 500 may include ten of these tunnels 1 arranged in a 360-degree configuration. This configuration allows usage of wind flow from any direction. Under normal-velocity airflow, the diversion/flow control baffles 3 may be set open for four of the ten tunnels 1 in the direction of incoming wind flow, Six diversion/flow control baffles 3 at the opposite side of the combustion chamber 5 may be set closed to divert the air upward into the chamber 5. This configuration may present a one hundred forty four degrees opening toward incoming wind and two hundred sixteen degrees of obstruction and up-flow. This will provide slightly compressed air inside the combustion chamber 5.

The system 5 may include inlet screens 2, and may be in several layers with the strongest screens at the outside level to deflect large flying debris expected during storms. Subsequent layers of the inlet screens 2 may guard against smaller items and finally a layer to keep birds out.

As discussed above, the system 500 may include wind diversion/flow control baffles 4. The upper surface of the baffles 4 located inside the tunnels that face the incoming wind will remain in line with the lower surface of their respective tunnels 1 except when used to limit incoming air to prevent over-pressure of the combustion chamber 5. When used to restrict the flow of air the baffles 4 may rotate upward to present a computer-positioned solid metal face to incoming wind and flying debris. The baffles 4 located on the opposite side of the combustion chamber 5 may be rotated upward to divert the incoming air upward into the compression chamber 5 and bar air from flowing into the tunnels 1 downwind of the combustion chamber 5.

The baffle upper and lower end-travel stops 4 may be used to stop the rotation of the baffles 4. The baffle lower stop 4 may insure a smooth continuation of the lower surface of their respective tunnel when in the fully ‘down’ or ‘opened’ state. The baffle upper stop 4 may insure a smooth upward airflow joint at the lower edge of the compression chamber 5.

The compression chamber 5 accepts air inflow as determined by the baffle settings and provides slightly compressed air upward into the turbine chamber 6. The upward airflow can be augmented by application of heat inside the compression chamber 5 on low-wind days.

The turbine chamber 6 may be configured to use a single wind-power driven rotor or multiple-stacked wind-power driven rotors. The example shown uses five stacked wind-powered drive rotors to use the accelerated airflow as a force-multiplying factor. The example also depicts a shaft housing that diverts the wind flow to the outer two thirds of the rotor blade's length to better utilize the power generating potential of the accelerated air flow. Also shown are multiple common-shaft driven alternators to allow flexibility of usage and to provide redundancy.

The silo 7 may be a shortened silo, but the increasing the height of the silo increases the efficiency of the power generation device.

FIG. 7 illustrates a sectional view of the upper portion of the system 500. The upper wind-flow baffles 8 may be used to create a downwind partial vacuum to enhance airflow through the structure. The baffles 8 may also provide protection from vacuum formed by vortices during very-high air speeds.

The walls 9 of the silo 7 may be insulated to prevent heat transfer and present a smooth inner wall to reduce friction to airflow.

The drive gears 10 may move the upper wind flow baffles 8.

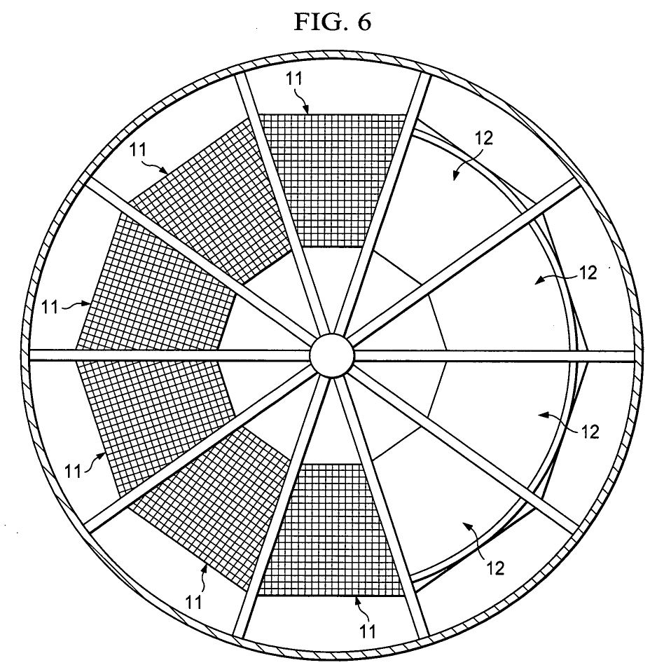

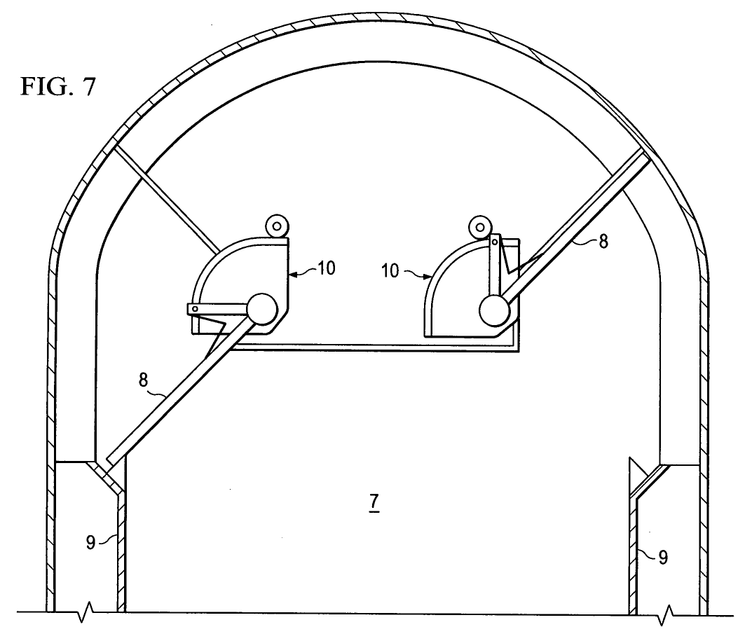

FIG. 6 illustrates the open and closed baffles 8. The closed baffles 11 of the wind flow baffles 8 may be set closed to restrict inlet of air from the direction of airflow.

The open baffles 12 of the wind flow baffles 8 may be set open to aid in overall airflow.

Some advantages of this device are:

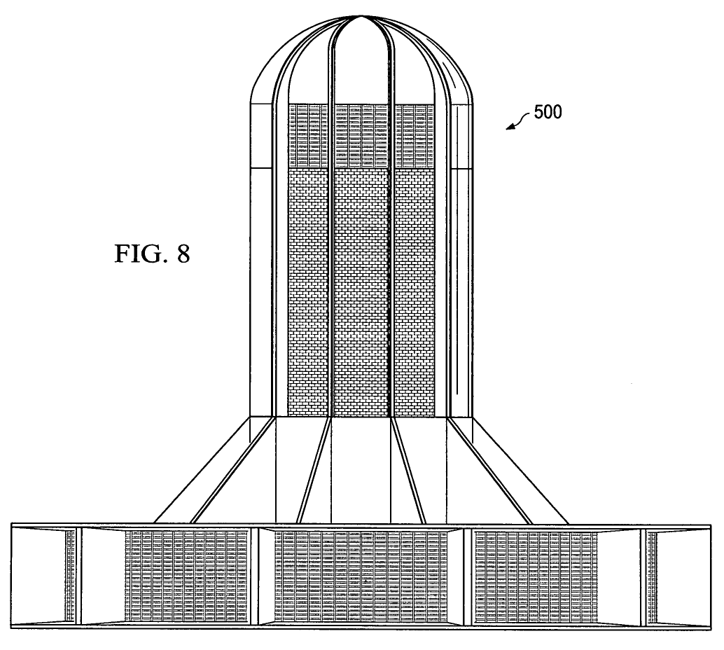

The device can be constructed to withstand Category 5 Hurricanes and Force 5 tornadoes. The lower baffles 3 can be shut to present a robust steel wall to block each inlet tunnel. The upper baffles 8 can be closed and the baffles 5 may be spring loaded to allow the pressure-differential between the silo 7 and the vacuum generated by a tornado to be relieved and then close instantly to exclude flying debris. The round external form as illustrated in FIG. 8 will not present a flat surface that would cause huge wind pressure-differential stress.

The device is attractive and will reduce bird-kill to almost zero. It will not generate the irritating low-frequency thump of the large exposed-blade windmills. These factors have caused widespread resistance to the use of wind generated power. The configuration also allows higher rotational speeds of the turbine to allow maximum power generation. The Turbine's RPM will be controlled by computerized positioning of the baffles. Detection of rapidly lowering of barometric pressure and erratic wind speeds and directions would signal a situation requiring complete shutdown of the structure and the baffles will respond to do so.

The structure is really a building with the expected useful life of a building. The generating components would be much easier to maintain. The turbine can be lowered into the compression chamber 5 after closing all baffles. Complete disassembly and major update procedures would not require an outside crane and calm wind conditions.

If the surrounding area will allow, large-capacity storage tanks of solar heated water pumped through heat-transfer radiators could be used to inject heat into the compression chamber 5 to utilize the updraft heat-rising properties of a chimney to bridge over periods of calm wind conditions.

Current open-blade wind turbines are limited in size by height and stability factors. The configuration of this system allows for a wide range of vertical and horizontal sizing considerations and can be built to fit requirements. Since the structure is essentially a building, height constraints would not apply and aircraft warning lights can be mounted at the highest point. The circular, lower wind-diversion component size would only be constrained by land “footprint” requirements. In both height and horizontal considerations, the larger the better. The turbine circumference may be limited by tip speed considerations. This may be compensated for with multiple stacked rotors to provide force multiplication at rotation speeds low enough to meet tip speed restrictions.

The enclosed Turbine Chamber provides several advantages over open-turbine designs. The rotor and support structures may not be subjected to the bending stresses and vibration endured by exposed open-turbine designs during storms. The wide range of wind velocities encountered by an open-rotor design during a storm may not produce vortices that cause rapidly changing directional stresses and severe vibrations of the entire structure. The base vibrations coupled with their many harmonics will not generate harmful stress within the many components of the structure as their resonant frequencies are met during the wide range of vibrations. These factors could limit the useful life of the structure.

A significant portion of the current horizontally oriented wind turbines' power is consumed in matching the output voltage frequency to that of the distribution grid. It may be possible to bypass this restriction requirement by using paralleled full-wave rectifiers to convert the alternating AC output to DC and either connecting solid-state variable frequency drives to produce AC at the frequency of the grid or using the DC to generate Hydrogen or both.

Hydrogen driven automobiles have been in research and development stages by several well known manufacturers for years: BMW is a good example. Also there is at least one company developing add-on hydride-granule-filled tanks to be used to provide a safe gasoline-or-hydrogen power capability to the millions of existing automobiles. The only drawback is the lack of a hydrogen supply structure. This add-on capability should bridge the gap between the automobiles of now and the purely hydrogen-driven vehicles of the future.

For more information concerning hydrogen storage hydrides, U.S. Pat. No. 5,443,616 which is incorporated by reference in its entirety for a description of one method of manufacture and an explanation of usage. The military has been exploring the dimensions of hydride storage of hydrogen for many years and found that certain hydrides absorb hydrogen like a sponge. They also found that bullets fired into one of these storage tanks did not cause an explosion, just a poof of flame and then a glowing ember much like a lighted cigarette. Controlled low temperature heating of the hydrides allows precise extraction of the hydrogen.

Another application is to use the power generated by this device to pump water from an existing lake or river up into a nearby water holding structure on a higher elevation. The water could then be used for hydroelectric generation as the water flows back into the original lake or river. The power used to pump the water would be from an infinitely renewable source and the water would be returned to its original location so there would be minimal environmental impact.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A power generator, comprising:
a housing to house the power generator;
an inlet chamber to import fluid;
a compression chamber to compress the fluid from the inlet chamber;
a turbine chamber including a vertical turbine to generate power from the compressed fluid;
an outlet chamber to output the exhaust fluid;
wherein the inlet chambers includes a rotatable baffle to open and close the inlet chamber.

2. A power generator as in claim 1, wherein the outlet chamber cooperates with the opening and closing of the baffles.

3. A power generator as in claim 1, wherein the outlet chamber includes an output port at the direction of the outlet port is opposed to the open baffles.

4. A power generator as in claim 1, wherein the generated power is used to store hydrogen.

5. A power generator as in claim 1, wherein the turbine includes at least five blades.

6. A power generator as in claim 5, wherein the turbine include a disk to cooperate with the turbine blades.

7. A power generator as in claim 1, wherein the fluid is air.
